(19) United States
(12) Patent Application Publication
(10) Pub. No.: US 2025/0019854 A1
(43) Pub. Date: Jan. 16, 2025

(54) COMPOSITE HARD CHROME PLATING

(71) Applicant: DIC Corporation, Tokyo (JP)

(72) Inventors: Ryo KANDA, Chiba (JP); Yoshiyuki SANO, Chiba (JP); Keisuke MATSUURA, Chiba (JP)

(21) Appl. No.: 18/710,922

(22) PCT Filed: Nov. 10, 2022
(86) PCT No.: PCT/JP2022/041825

§ 371 Date: May 16, 2024

(30) Foreign Application Priority Data
Nov. 18, 2021 (JP) 2021-187743

(51) Int. Cl. C25D 3/06; F16J 9/26

(52) U.S. Cl. CPC C25D 3/06; F16J 9/26

(57) ABSTRACT

The present invention aims to provide, under practical chrome plating conditions, a composite hard chrome plating film that suppresses non-adhesive regions between the plating film and ceramic particles, has fewer defects as a film, and is excellent in hardness and wear resistance, and also a sliding member coated with the film. Specifically, provided is a composite hard chrome plating film including tabular alumina, the composite hard chrome plating film being characterized in that the chromium source of the composite hard chrome plating film is trivalent chromium, and the ratio A/B of the amount of acid adsorption A per surface area (μmol/m²) to the amount of base adsorption B per surface area (μmol/m²) of the tabular alumina is 0.5 or more and 1.5 or less.

### TECHNICAL FIELD

The present invention relates to a composite hard chrome plating film, the composite hard chrome plating film using trivalent chromium, and also to a sliding member, such as a piston ring, coated with the film.

### BACKGROUND ART

Generally, chromium plating can maintain metallic luster for a long time because of its excellent corrosion resistance and discoloration resistance, and thus has been widely used as decorative plating. In addition, chrome plating offers a high hardness of about 800 to 950 Hv, is excellent in wear resistance, has a low wear coefficient, and thus has been widely used as hard chrome plating for mechanical parts and the like. However, in a plating solution used for such plating, harmful hexavalent chromium is used as a main component. From the viewpoint of health and environmental conservation, hexavalent chromium is designated as a substance of high concern, and there has been a need to develop chromium plating without using hexavalent chromium.

Chrome plating using, as an alternative to hexavalent chromium, less toxic trivalent chromium has been proposed. As relatively thin plating with a film thickness of 5 μm or less, trivalent chromium plating is excellent in color tone and corrosion resistance, and thus has been put to practical use as decorative plating. However, as hard chrome plating, its wear resistance (wear coefficient) is not necessarily high enough, and practical use has not been reached yet.

Thus, as methods for improving wear resistance, methods in which a plurality of ceramic particles having excellent wear resistance are added to chromium plating in an amount of 10 to 30% by volume have been proposed (PTL 1, PTL 2, PTL 3). In addition, focusing on the presence of correlation between plating hardness and wear resistance, a method in which tabular and/or fibrous alumina particles are added to suppress the expansion and propagation of cracks during a heat treatment, thereby improving hardness, has been proposed (PTL 4).

By the way, it is known that in the case where ceramic particles are used for composite plating, because the specific gravity of ceramic particles is generally high, the particles are likely to sediment. Therefore, when forming a composite plating film, for the purpose of suppressing the sedimentation of particles, an operation of strongly stirring or shaking the plating solution is required.

However, in a composite plating film formed by such a method, the affinity between the ceramic particles used and the deposited plating film is low, and it thus has sometimes happened that particles are shed from the plating film during the treatment, resulting in insufficient incorporation of ceramic particles, and also that because of the particle shed portion, the formation of the composite plating film is incomplete. In addition, in the formed composite plating film, a non-adhesive region is observed between the plating film and ceramic particles, and a composite plating film with sufficient hardness and wear resistance has not been achieved.

### CITATION LIST

### Patent Literature

PTL 1: JP2013-241656A
PTL 2: JP2016-216833A
PTL 3: JP2018-159099A
PTL 4: JP2014-196533A

### SUMMARY OF INVENTION

### Technical Problem

Therefore, the invention addresses the problem of providing, under practical chrome plating conditions, a composite hard chrome plating film that suppresses non-adhesive regions between the plating film and ceramic particles, has fewer defects as a film, and is excellent in hardness and wear resistance, and also a sliding member coated with the film.

### Solution to Problem

The present inventors have conducted a detailed study on the state of ceramic particles during the formation of a composite hard chrome plating film. As a result of extensive research, they have found that when tabular alumina particles in which the ratio A/B of the amount of acid adsorption A per surface area (μmol/m²) to the amount of base adsorption B per surface area (μmol/m²) is 0.5 or more and 1.5 or less are added to chrome plating using trivalent chromium as a chromium source, the affinity between alumina particles and the plating film is ensured, and a plating film that suppresses non-adhesive regions between the particles and the plating metal can be obtained; as a result, a plating film that suppresses cracking and is excellent in hardness and wear resistance can be obtained.

That is, the invention relates to a composite hard chrome plating film including tabular alumina, in which the chromium source of the composite hard chrome plating film is trivalent chromium, and the ratio A/B of the amount of acid adsorption A per surface area (μmol/m²) to the amount of base adsorption B per surface area (μmol/m²) of the tabular alumina is 0.5 or more and 1.5 or less.

### Advantageous Effects of Invention

The composite hard chrome plating film of the invention has excellent affinity between the plating film and alumina particles and suppresses the occurrence of non-adhesive regions, consequently leading to suppressed cracking, and the formed film is excellent in hardness and wear resistance. Therefore, its application to a sliding member, such as a piston ring, is suitable.

### BRIEF DESCRIPTION OF DRAWINGS

FIG. 1 is a cross-sectional SEM image of an alumina-dispersed Cr plating film obtained in Example 1.

FIG. 2 is a cross-sectional SEM image of an alumina-dispersed Cr plating film obtained in Comparative Example 2.

FIG. 3 is a 3D image of scratches on the alumina-dispersed Cr plating film obtained in Example 1, observed with a laser microscope.

FIG. 4 is a 3D image of scratches on the alumina-dispersed Cr plating film obtained in Comparative Example 1, observed with a laser microscope.

### DESCRIPTION OF EMBODIMENTS

Hereinafter, an embodiment of the invention will be described in detail. The invention is not limited to the following embodiments, and can be implemented with appropriate modifications without impeding the effects of the invention.

### <Composite Hard Chrome Plating Film>

A composite hard chrome plating film is a plating film formed by adding ceramic particles, which are hard particles, to a chromium plating solution, followed by co-deposition with chromium. The purpose of the ceramic particles is to improve the wear resistance of the plating film, and examples thereof include alumina, silicon carbide, and diamond. The plating film according to this embodiment contains tabular alumina particles. Because of the tabular shape of alumina particles, when a plating film is formed on the substrate, the alumina particles are oriented along the substrate, making it possible to reduce damage to a partner material, which serves as the friction partner.

### <Chromium Plating Solution>

The chromium plating solution uses trivalent chromium as a chromium source. Because trivalent chromium is used, there is no need to use highly toxic hexavalent chromium. The trivalent chromium plating solution may be prepared as appropriate according to a known composition and used, or it is also possible to use a commercially available trivalent chromium plating solution. As commercially available products, TOP FINE CHROME SP and TOP FINE CHROME LG (manufactured by OKUNO Chemical Industries Co., Ltd.), JCUTRICHROM JTC series (manufactured by JCU Corporation), Envirochrome and CP series (MacDermid Performance Solutions Japan K.K.), and the like can be mentioned.

### <Method for Forming Composite Hard Chrome Plating Film>

A method for forming the composite hard chrome plating film of the invention includes preparing a chrome plating bath containing the above chromium plating solution and the below-described tabular alumina particles, and forming a plating film on the object by a known conventional electroplating method.

### <Tabular Alumina Particles>

“Alumina” as used in the invention is aluminum oxide, and is not particularly limited as long as the ratio A/B of the amount of acid adsorption A per surface area (μmol/m²) to the amount of base adsorption B per surface area (μmol/m²) is met. For example, transition aluminas in various crystalline forms, such as γ,δ, θ, and κ, are possible, and alumina hydrates in transition aluminas may also be included. However, basically, the α-crystalline form is preferable because of its higher stability.

“Tabular” as used in the invention indicates that the aspect ratio obtained by dividing the average particle size by the thickness is 2 or more. Incidentally, as used herein, as “thickness of tabular alumina particles”, a value measured using a scanning electron microscope (SEM) is employed. In addition, “average particle size of tabular alumina particles” is a value of the volume-based median diameter D50 calculated from the volume-based cumulative particle size distribution measured using a laser diffraction/scattering particle size distribution measuring device.

The average particle size of the tabular alumina particles can be selected as appropriate depending on the intended use of the plated object, the thickness of the plating film, and the like, but is, especially, preferably 0.5 μm or more and 20 μm or less, and particularly preferably 1 μm or more and 10 μm or less. When the tabular alumina particles have an average particle size of 0.5 μm or more, the aggregation of particles is suppressed, while when it is 20 μm or less, the area of alumina particles functioning as an insulator decreases, and the growth of the plating film improves; therefore, this is preferable.

The aspect ratio of the tabular alumina particles can be selected as appropriate depending on the intended use of the plated object, the thickness of the plating film, and the like, but is, especially, preferably 5 or more and 100 or less, and particularly preferably 10 or more and 50 or less. When the tabular alumina particles have an aspect ratio within the above range, the formed plating film has a smooth surface, is excellent in wear resistance, and is less aggressive against the partner material; thus, this is a preferred embodiment.

The ratio A/B of the amount of acid adsorption A per surface area (μmol/m²) to the amount of base adsorption B per surface area (μmol/m²) of the tabular alumina particles is 0.5 or more and 1.5 or less, particularly preferably 0.7 or more and 1.3 or less. Within the above range, the affinity between the plating film and the tabular alumina particles increases, and, in the formed plating film, non-adhesive regions between the plating film and the tabular alumina particles are suppressed. In particular, from the viewpoint of adhesion with the plating film after film formation, it is more preferable that the amount of acid adsorption A per surface area (μmol/m²) is 0.5 μmol/m² or more and 3.5 μmol/m² or less.

Although it has not been clarified in detail how the acid and base adsorption amounts per surface area of tabular alumina particles affect the adhesion between the alumina particles and the plating film, the following hypothesis can be raised.

Generally, the amount of acid adsorption per surface area of particles is believed to reflect the surface potential of the particles. That is, particles with a larger amount of acid adsorption are particles that are more negatively charged. In the case where, as in electroplating, positive and negative electrodes are immersed in a solution, and a voltage is applied, negatively charged particles basically migrate toward the positive electrode. However, by stirring or shaking the plating solution, negatively charged particles are also easily incorporated into a plating film generated on the negative electrode side.

Meanwhile, in a strongly acidic solution like a trivalent chromium plating solution, negatively charged particles attract cations and turn into positively charged colloidal particles. For example, the zeta potential of general ceramic particles becomes positive. Also in the case of commercially available alumina particles, which are said to be negatively charged, the zeta potential measured was about +20 mV in a solution of pH 2. In this case, on the negative electrode surface where a plating film is deposited, metal cations turn into a state of being accumulated in layers due to the electrode potential, and positively charged colloid particles turn, even if they could approach, into a state of having poor affinity with the cation layers. Through such a state, while incorporating ceramic particles, metal cations are reduced, and a plating film is generated.

The above background has led to an idea that particles capable of forming colloidal particles having a low zeta potential in a low pH region, that is, particles with a small amount of acid adsorption per surface area, are suitable for ceramic particle composite chromium plating.

In addition, further, as the composite plating co-deposition mechanisms, in addition to the mechanism in which metal ions and ceramic particles are individually deposited on the negative electrode as described above, a mechanism in which metal ions are adsorbed onto ceramic particles dispersed in plating, and they become like a composite and deposited on the negative electrode, can be supposed. In this case, presumably, alumina particles with a large amount of acid adsorption form positively charged colloidal particles in a strongly acidic solution, and thus have low affinity with metal ions and repel metal ions both in the plating solution and on the negative electrode, and they are deposited while remaining in a state of not sufficiently adhering to each other. Meanwhile, presumably, alumina particles with a large amount of base adsorption do not form positively charged colloidal particles, that is, have low affinity with metal ions to begin with, and thus are deposited while remaining in a state of not sufficiently adhering to metal ions both in the plating solution and on the negative electrode. Therefore, it is supposed that when the amount of acid or base adsorption of alumina particles is more uniform, a decrease in the affinity with metal ions is more suppressed, which relatively increases the adhesion, and non-adhesive regions become less likely to occur between the plating film and the alumina particles.

These ideas have led to an idea that not only the amount of acid adsorption of the alumina particles used but also the amount of base adsorption is important in suppressing the occurrence of non-adhesive regions.

### <Method for Producing Tabular Alumina Particles>

The method for producing tabular alumina particles is not particularly limited, and known conventional techniques such as a hydrothermal method and a flux method can be applied as appropriate. However, from the view point that alumina particles in which the ratio A/B of the amount of acid adsorption A per surface area (μmol/m²) to the amount of base adsorption B per surface area (μmol/m²) is 0.5 or more and 1.5 or less can be suitably controlled, a production method by a flux method using a molybdenum compound and a shape control agent can be preferably applied.

More specifically, a preferred method for producing tabular alumina particles includes firing an aluminum compound in the presence of a molybdenum compound and a shape control agent.

### [Firing Step]

The firing step is a step of firing an aluminum compound in the presence of a molybdenum compound and a shape control agent.

### (Aluminum Compound)

The aluminum compound is a raw material for the tabular alumina particles used in the invention, and is not particularly limited as long as it turns into alumina through a heat treatment. For example, aluminum chloride, aluminum sulfate, basic aluminum acetate, aluminum hydroxide, boehmite, pseudo-boehmite, transition aluminas (α-alumina, δ-alumina, θ-alumina, etc.), α-alumina, mixed alumina having two crystal phases, and the like can be used. The physical morphology of such an aluminum compound as a precursor, such as shape, particle size, and specific surface area, is not particularly limited.

According to the below-described flux method, the shape of the raw material aluminum compound is hardly reflected in the shape of tabular alumina particles. Therefore, any of a spherical shape, an amorphous shape, a structure with aspect ratio (wire, fiber, ribbon, tube, etc.), a sheet, and the like, for example, can be suitably used.

Similarly, the particle size of the aluminum compound is hardly reflected in tabular alumina particles according to the below-described flux method. Therefore, solid aluminum compounds ranging from several nm to several hundred μm can be suitably used.

The specific surface area of the aluminum compound is not particularly limited either. In order for molybdenum to act effectively, a larger specific surface area is more preferable. However, by adjusting the firing conditions and the amount of molybdenum used, materials with any specific surface area can be used as raw materials.

### (Shape Control Agent)

In order to form tabular alumina particles suitable for the invention, it is more preferable to use a shape control agent. The shape control agent not only affects the surface properties of the produced alumina particles, but also promotes the growth of tabular alumina crystals through the firing of an alumina compound in the presence of molybdenum.

The state of existence of the shape control agent is not particularly limited as long as it can come into contact with the aluminum compound. For example, a physical mixture of the shape control agent and the aluminum compound, a composite in which the shape control agent exists uniformly or locally on the surface of or inside the aluminum compound, and the like can be suitably used.

In addition, the shape control agent may be added to the aluminum compound, or may also be contained as an impurity in the aluminum compound.

The kind of shape control agent is not particularly limited as long as during high-temperature firing in the presence of a molybdenum compound, selective adsorption of molybdenum oxide onto the α-alumina [113] plane is suppressed, and a tabular morphology can be formed. In terms of having a higher aspect ratio, better dispersibility, and better productivity, metal compounds other than molybdenum compounds and aluminum compounds are preferably used. Specific examples of shape control agents include a silicon atom, a sodium atom, a germanium atom, and a potassium atom, as well as compounds thereof, but shape control agents encompassed by the invention are not limited to the above elements and compounds.

The silicon atom and silicon compounds are not particularly limited, and known ones can be used. Specifically, artificially synthesized silicon compounds such as metallic silicon, organic silane, silicon resin, silica fine particles, silica gel, mesoporous silica, SiC, and mullite; natural silicon compounds such as biosilica, and the like can be mentioned. Among them, it is preferable to use organic silane, silicon resin, and silica fine particles from the viewpoint that a composite or mixture with an aluminum compound can be formed more uniformly. Incidentally, the silicon atom and silicon compounds may be used alone, or it is also possible to use a combination of two or more kinds.

The shape of silicon atom or silicon compound is not particularly limited, and, for example, a spherical shape, an amorphous shape, a structure with aspect ratio (wire, fiber, ribbon, tube, etc.), a sheet, or the like can be suitably used.

The amount of silicon atom or silicon compound used is not particularly limited, but is preferably 0.0001 to 1 mol, more preferably 0.001 to 0.5 mol, per mole of aluminum metal in the aluminum compound. When the amount of silicon atom or silicon compound used is within the above range, tabular alumina particles having a high aspect ratio and excellent dispersibility are likely to be obtained; therefore, this is preferable.

Particularly in the case where a silicon atom or silicon compound is used, from the viewpoint of adhesion between the filler and the plating, it is preferable to form mullite on part of the alumina surface of the final product.

The sodium atom and sodium compounds are not particularly limited, and known ones can be used. As specific examples of the sodium atom and sodium compounds, sodium carbonate, sodium molybdenum, sodium oxide, sodium sulfate, sodium hydroxide, sodium nitrate, sodium chloride, metallic sodium, and the like can be mentioned. Among them, it is preferable to use sodium carbonate, sodium molybdenum acid, sodium oxide, or sodium sulfate from the viewpoint of industrial availability and ease of handling. Incidentally, the sodium atom and sodium compounds may be used alone, or it is also possible to use a combination of two or more kinds.

The shape of the sodium atom or sodium compound is not particularly limited, and, for example, a spherical shape, an amorphous shape, a structure with aspect ratio (wire, fiber, ribbon, tube, etc.), a sheet, or the like can be suitably used.

The amount of sodium atom or sodium compound used is not particularly limited, but is preferably 0.0001 to 2 mol, more preferably 0.001 to 1 mol, per mole of aluminum metal in the aluminum compound. When the amount of sodium or sodium atom-containing compound used is within the above range, tabular alumina particles having a high aspect ratio and excellent dispersibility are likely to be obtained; therefore, this is preferable.

The germanium atom and germanium compounds are not particularly limited, and known ones can be used. As specific examples of the germanium atom and germanium compounds, germanium metal, germanium dioxide, germanium monoxide, germanium tetrachloride, organic germanium compounds having a Ge—C bond, and the like can be mentioned. Incidentally, the germanium atom and germanium compounds may be used alone, or it is also possible to use a combination of two or more kinds.

The shape of the germanium atom or germanium compound is not particularly limited, and, for example, a spherical shape, an amorphous shape, a structure with aspect ratio (wire, fiber, ribbon, tube, etc.), a sheet, or the like can be suitably used.

The potassium atom and potassium compounds are not particularly limited, and potassium chloride, potassium chlorite, potassium chlorate, potassium sulfate, potassium hydrogen sulfate, potassium sulfite, potassium hydrogen sulfite, potassium nitrate, potassium carbonate, potassium hydrogen carbonate, potassium acetate, potassium oxide, potassium bromide, potassium bromate, potassium hydroxide, potassium silicate, potassium phosphate, potassium hydrogen phosphate, potassium sulfide, potassium hydrogen sulfide, potassium molybdate, potassium tungstate, and the like can be mentioned. In this case, the potassium compounds include isomers. Among them, it is preferable to use potassium carbonate, potassium hydrogen carbonate, potassium oxide, potassium hydroxide, potassium chloride, potassium sulfate, or potassium molybdate, and it is more preferable to use potassium carbonate, potassium hydrogen carbonate, potassium chloride, potassium sulfate, or potassium molybdate. Incidentally, the potassium compounds may be used alone, or it is also possible to use a combination of two or more kinds.

### (Molybdenum Compound)

As described below, a molybdenum compound has a fluxing function on the growth of alumina α-crystals at relatively low temperatures. Molybdenum compounds are not particularly limited, and molybdenum oxide and also compounds containing an acid radical anion (MoOx n-) composed of molybdenum metal combined with oxygen can be mentioned.

The compounds containing an acid radical anion (MoOx n-) are not particularly limited, and molybdic acid, sodium molybdate, potassium molybdate, lithium molybdate, H₃PMo₁₂O₄₀, H₃SiMo₁₂O₄₀, NH₄Mo₇O₁₂, molybdenum disulfide, and the like can be mentioned.

A molybdenum compound can also contain a silicon atom and/or a silicon compound or a potassium compound. In that case, the molybdenum compound containing a silicon atom and/or a silicon compound or a potassium compound serves as both a flux agent and a shape control agent.

Among the molybdenum compounds described above, from the viewpoint of cost, it is preferable to use molybdenum oxide. In addition, the molybdenum compounds may be used alone, or it is also possible to use a combination of two or more kinds.

The amount of molybdenum compound used is not particularly limited, but is preferably 0.01 to 3.0 mol, more preferably 0.03 to 0.7 mol, per mole of aluminum metal in the aluminum compound. When the amount of molybdenum compound used is within the above range, tabular alumina particles having a high aspect ratio and excellent dispersibility are likely to be obtained; therefore, this is preferable.

### (Firing)

The method for firing is not particularly limited and may be a known conventional method. When the firing temperature exceeds 700° C., an aluminum compound reacts with a molybdenum compound to form aluminum molybdate. Further, when the firing temperature is 900° C. or more, aluminum molybdate decomposes and, under the action of the shape control agent, forms tabular alumina particles. In addition, when aluminum molybdate decomposes and becomes alumina and molybdenum oxide, tabular alumina particles are obtained as a result of the incorporation of the molybdenum compound into aluminum oxide particles.

In addition, at the time of firing, the states of the aluminum compound, shape control agent, and molybdenum compound are not particularly limited as long as they exist in the same space where the molybdenum compound and the shape control agent can act on the aluminum compound. Specifically, it is possible to perform simple mixing of mixing powders of the molybdenum compound, shape control agent, and aluminum compound, mechanical mixing using a grinder or the like, or mixing using a mortar or the like, and it is also possible to perform mixing in a dry state or a wet state.

The firing temperature conditions are not particularly limited and are determined as appropriate depending on the average particle size, aspect ratio, and the like of the intended tabular alumina particles. Generally, the firing temperature needs to be such that the maximum temperature is equal to or higher than 900° C., which is the decomposition temperature of aluminum molybdate (Al₂(MoO₄)₃).

With respect to the firing temperature, firing can be performed even at a high firing temperature exceeding 2,000° C. However, even at a temperature of 1,600° C. or less, which is considerably lower than the melting point of α-alumina, regardless of the shape of the precursor, α-alumina having a high α-crystallization rate and forming a tabular shape with a high aspect ratio can be formed.

Under conditions where the maximum firing temperature is 900° C. to 1,600° C., tabular alumina particles with a high aspect ratio and an α-crystallization rate of 90% or more can be formed efficiently at low cost. Firing with a maximum temperature of 950 to 1,500° C. is more preferable, and firing with a maximum temperature within a range of 980 to 1,400° C. is most preferable.

With respect to the time of firing, it is preferable that the temperature is raised to a predetermined maximum temperature over a period of time within a range of 15 minutes to 10 hours, and the holding time at the maximum firing temperature is within a range of 5 minutes to 30 hours. In order to efficiently form tabular alumina particles, it is more preferable that the firing holding time is about 10 minutes to 15 hours.

By selecting conditions such that the maximum temperature is 1,000 to 1,400° C. and the firing holding time is 10 minutes to 15 hours, tabular alumina particles in the dense α-crystal form can be easily obtained with less likelihood of agglomeration.

The atmosphere of firing is not particularly limited as long as the effects of the invention can be obtained. For example, an oxygen-containing atmosphere, such as air or oxygen, and an inert atmosphere, such as nitrogen or argon, are preferable. In consideration of cost, an air atmosphere is more preferable.

The apparatus for firing is not necessarily limited either, and a so-called firing furnace can be used. The firing furnace is preferably made of a material that does not react with sublimed molybdenum oxide. Further, in order to efficiently utilize the molybdenum oxide, it is preferable to use a highly hermetic firing furnace.

### [Molybdenum Removal Step]

The method for producing tabular alumina particles may further include, after the firing step, if necessary, a molybdenum removal step of removing at least part of molybdenum.

As described above, because molybdenum sublimes during firing, the molybdenum content in the tabular alumina particles can be controlled by controlling the firing time, the firing temperature, and the like.

Molybdenum can adhere to the surface of tabular alumina particles. Such molybdenum can be removed by cleaning with water, an ammonia aqueous solution, a sodium hydroxide aqueous solution, or an acidic aqueous solution.

At this time, by changing the concentration of ammonia aqueous solution, sodium hydroxide aqueous solution, or acidic aqueous solution used, the amount of these aqueous solution or the water used, the region to be cleaned, the cleaning time, and the like as appropriate, the molybdenum content can be controlled.

Further, by adjusting the concentration of the cleaning solution used in this step, the amount used, and the cleaning time as appropriate, the amounts of acid adsorption and base adsorption per surface area of the alumina particles can be further controlled.

### [Pulverization Step]

Tabular alumina particles in a fired material may aggregate and may not meet the particle size range suitable for the invention. Therefore, tabular alumina particles may be, if necessary, pulverized to meet the particle size range suitable for the invention. The method for pulverizing a fired material is not particularly limited, and conventionally known pulverizing methods such as a ball mill, a jaw crusher, a jet mill, a disk mill, SpectroMill, a grinder, a mixer mill, and the like are applicable.

### [Classification Step]

Further, the tabular alumina particles may preferably be subjected to a classification treatment for adjustment to the average particle size suitable for the invention. “Classification treatment” refers to an operation of dividing particles into groups according to the size. Classification may be either wet or dry. However, from the viewpoint of productivity, dry classification is preferable. Dry classification includes classification using a sieve, as well as air classification in which particles are classified based on the difference in centrifugal force and fluid drag, etc. From the viewpoint of classification accuracy, air classification is preferable, and can be performed using a classifier such as an airflow classifier using the Coanda effect, a swirling airflow classifier, a forced vortex centrifugal classifier, or a semi-free vortex centrifugal classifier. The pulverization step and classification step described above can be performed at a necessary stage, including before and after the below-described organic compound layer forming step. By selecting whether to perform such pulverization and classification and the conditions thereof, for example, the average particle size of the resulting tabular alumina particles can be adjusted.

Tabular alumina particles with little or no agglomeration are preferable from the viewpoint that such particles are likely to exhibit their original properties, are more excellent in their own handleability, and have better dispersibility when dispersed in a dispersion medium and used. In the method for producing tabular alumina particles, it is preferable that particles with little or no agglomeration can be obtained without the pulverization step and classification step described above because, as a result, there is no need to perform the above steps, and intended tabular alumina having excellent properties can be produced with high productivity.

### EXAMPLES

Next, the invention will be specifically described with reference to examples and comparative examples. In the following description, “parts” and “%” are based on mass unless otherwise specified. Incidentally, composite hard chrome plating films were formed under the conditions shown below, and the obtained plating films were measured and evaluated under the following conditions.

### <Evaluation of Film Thickness of Plating Film>

A cross-section of a prepared sample was observed with a microscope, and the film thickness was measured.

### <Plating Film Hardness Measurement>

An obtained plating film was measured using Shimadzu Dynamic Ultra Micro Hardness Tester DUH211Y (manufactured by Shimadzu Corporation) under a load of 100 gf×14 sec.

### <Plating Film Wear Resistance Test>

With respect to an obtained plating film, the wear coefficient and scratches were evaluated using a Tribometer (manufactured by CSM Instruments). As the friction partner material, SUJ2 (ball shape, dimension: 9.00 mm) was used. The measurement conditions were as follows: contact load:2.00 N, friction speed:5.00 cm/s, friction time: 600 seconds. The evaluation of scratches was performed by laser microscope 3D observation of scratches after the measurement. When the surface was not depressed, a rating of “A” was given, while when depressed, “B” was given.

<Adhesion between Plating and Filler>

A cross-section of a prepared sample was observed under SEM. It was visually checked whether there was a gap between the plating and the filler as a result of the observation, and when no gap was observed, a rating of “A” was given, while when a gap was observed, “B” was given.

### (Synthesis Example 1) Synthesis of Tabular Alumina Particles

50 g of aluminum hydroxide (manufactured by Nippon Light Metal Co., Ltd., average particle size: 12 μm), 0.65 g of silicon dioxide (manufactured by Kanto Chemical Co., Inc., special grade), and 1.72 g of molybdenum trioxide (manufactured by Taiyo Koko Co., Ltd.) were mixed in a mortar to obtain a mixture. The obtained mixture was placed in a crucible, and, in a ceramic electric furnace, the temperature was raised to 1,200° C. at 5° C./min and held at 1,200° C. for 10 hours to perform firing. Subsequently, the temperature was lowered to room temperature under a condition of 5° C./min, and the crucible was taken out, thereby giving 34.2 g of a light blue powder. The obtained powder was crushed in a mortar until it passed through a 106-μm sieve.

Subsequently, the obtained light blue powder was dispersed in 150 mL of a 0.5% aqueous ammonia, and the dispersed solution was stirred at room temperature (25 to 30° C.) for 0.5 hours. The aqueous ammonia was then removed by filtration, followed by cleaning with water and drying to remove molybdenum remaining on the particle surface, thereby giving 33.5 g of a light blue powder. The obtained powder was observed under SEM and found to have a tabular shape with very few aggregates, that is, found to be particles having a tabular shape with excellent handleability. Further, as a result of XRD measurement, sharp scattering peaks derived from α-alumina appeared, and, besides the α-crystal structure, no other alumina crystal-derived peaks were observed, finding that the particles were tabular alumina particles with a dense crystalline structure. In addition, the α-conversion rate was 99% or more (almost 100%). Further, from the results of fluorescent X-ray quantitative analysis, the obtained particles were found to contain 0.8% molybdenum in terms of molybdenum trioxide and 1.9% silicon in terms of silicon dioxide.

### <Measurement of Amount of Acid Adsorption of Alumina Particles>

Using potentiometric titration COM-1700 (manufactured by Hiranuma Sangyo Co., Ltd.), alumina particles were measured for the amount of acid adsorption. 15 mL of a 0.001 mol/L p-toluenesulfonic acid (PTSA)/n-propyl acetate (NPAC) solution was added to 1 g of alumina particles and mixed using a rotation/revolution stirrer (2,000 rpm, 3 minutes). Next, the mixture was centrifuged (8,000 rpm, 20 minutes) to sediment the alumina particles. 10 mL of the supernatant was taken and subjected to potentiometric titration to measure the amount of unadsorbed acid present in the supernatant solution. The unadsorbed amount determined was subtracted from the amount of acid added, thereby calculating the amount of acid adsorption of the alumina particles. The amount of acid adsorption A per surface area was 2.5 μmol/m².

### <Measurement of Amount of Base Adsorption of Alumina Particles>

Using potentiometric titration COM-1700 (manufactured by Hiranuma Sangyo Co., Ltd.), alumina particles were measured for the amount of base adsorption. 15 mL of a 0.001 mol/L tetrabutyl ammonium hydroxide (TBAH)/NPAC solution was added to 1 g of alumina particles and mixed using a rotation/revolution stirrer (2,000 rpm, 3 minutes). Next, the mixture was centrifuged (8,000 rpm, 20 minutes) to sediment the alumina particles. 10 mL of the supernatant was taken and subjected to potentiometric titration to measure the amount of unadsorbed base present in the supernatant solution. The unadsorbed amount determined was subtracted from the amount of base added, thereby calculating the amount of base adsorption of the alumina particles. The amount of base adsorption B per surface area was 2.3 μmol/m².

### (Measurement of Specific Surface Area: BET Method)

The specific surface area can be determined as the surface area per gram of tabular alumina particles measured by a BET nitrogen gas adsorption/desorption method, such as JIS Z 8830: BET 1-point method (adsorbed gas: nitrogen). More specifically, a sample of alumina particles was pretreated under the conditions of 300° C. and 3 hours, and then the specific surface area of the pretreated sample was measured using TriStar 3000 manufactured by Micromeritics. The specific surface area was 1.7 m²/g.

### (Measurement of Average Particle Size L)

With respect to the tabular alumina particles obtained in Synthesis Example 1, using a laser diffraction particle size distribution analyzer HELOS (H3355) & RODOS (manufactured by Japan Laser Corporation), the median diameter D50 (μm) was determined under the conditions of a dispersion pressure of 3 bar and a suction pressure of 90 mbar and taken as the average particle size L (μm). The average particle size L was 9.5 μm.

### (Measurement of Average Thickness D)

With respect to the above sample, the thicknesses of 50 particles were measured using a scanning electron microscope (SEM), averaged, and taken as the average thickness D (μm). The average thickness D was 0.63 μm.

The aspect ratio L/D of the tabular alumina particles was calculated using the following formula. The aspect ratio L/D was 15.

### (Aspect Ratio L/D)

Aspect ratio=Average particle size L of tabular alumina particles/average thickness D of tabular alumina particles

Similarly, the filler used in Comparative Example 1 was also evaluated for the acid and base adsorption amounts per surface area, the average particle size L, the average thickness D, and the aspect ratio L/D.

The analysis of the α-conversion rate and the Mo amount of the tabular alumina particles obtained in Synthesis Example 1 was performed by the following methods.

### (Analysis of Amount of Mo Contained in Tabular Alumina Particles)

Using a fluorescent X-ray analyzer Primus IV (manufactured by Rigaku Corporation), about 70 mg of a prepared sample was placed on a filter paper, covered with a PP film, and analyzed for composition. The amount of molybdenum determined from XRF analysis results was determined in terms of molybdenum trioxide (mass %) based on 100 mass % of tabular alumina particles.

### (Analysis of α-Conversion Rate of Tabular Alumina Particles)

A prepared sample was placed on a measurement sample holder with a depth of 0.5 mm to evenly fill the holder under a constant load, then set in a wide-angle X-ray diffraction device (Rint-Ultma, manufactured by Rigaku Corporation), and subjected to measurement under the following conditions: Cu/Kα rays, 40 kV/30 mA, scanning speed: 2°/min, scanning range: 10 to 70°. From the ratio between the heights of the strongest α-alumina and transition alumina peaks, the α-conversion rate was calculated.

### Example 1

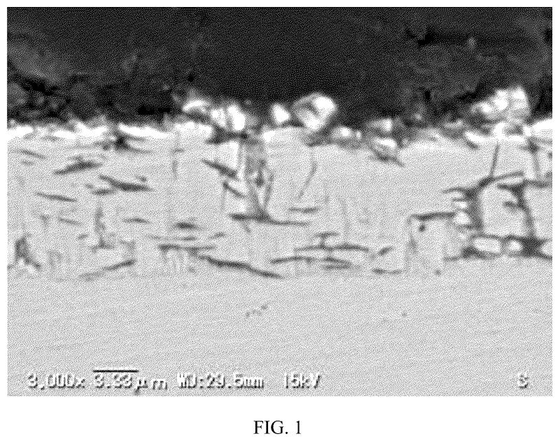

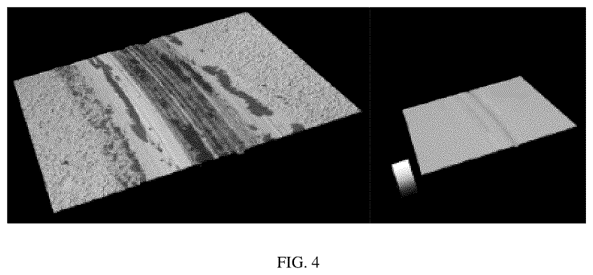

The tabular alumina of Synthesis Example 1 was added to a commercially available trivalent chromium plating solution TOP FINE CHROME LG (manufactured by OKUNO Chemical Industries Co., Ltd.) at a concentration of 20 g/L. A cleaning-treated iron plate was immersed in the above plating bath, and, using the iron plate as the negative electrode and the counter electrode as the positive electrode, while stirring the plating bath, a composite hard chromium plating treatment was performed at a current density of 20 A/dm² and a plating bath temperature of 35° C. to 40° C. for an application time of 40 minutes, thereby forming a composite hard chrome plating film having a film thickness of about 10 μm on the iron plate. From the obtained composite hard chrome plating film, the adhesion between the plating film and the filler was evaluated, as well as scratches thereon (FIGS. 1 and 3).

### Comparative Example 1

A composite hard chrome plating film having a film thickness of about 10 μm was formed on (an iron plate) in the same manner as in Example 1, except that commercially available tabular alumina particles YFA10030 (manufactured by Kinsei Matec Co., Ltd.) were used as tabular alumina particles. From the obtained composite hard chrome plating film, the adhesion between the plating film and the filler was evaluated, as well as scratches thereon (FIG. 4).

### Comparative Example 2

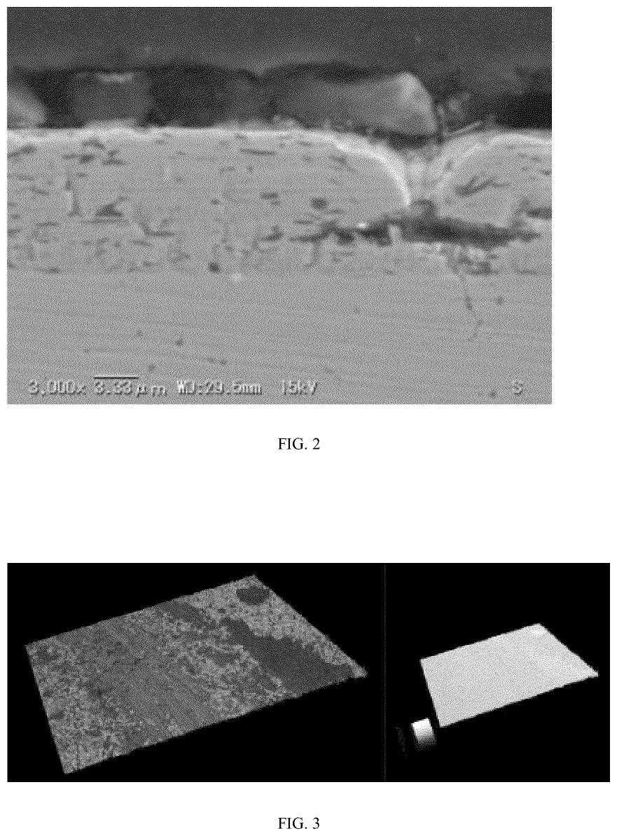

A chromium plating film having a thickness of about 10 μm was formed on (an iron plate) in the same manner as in Example 1, except that tabular alumina particles were not added. From the obtained composite hard chrome plating film, the adhesion between the plating film and the filler was evaluated, as well as scratches thereon (FIG. 2).

TABLE 1

| | | | Comparative | Comparative |
|---|---|---|---|---|
| | | Example 1 | Example 1 | Example 2 |
| Alumina | Average Particle Size (μm) | 9.5 | 9.3 | — |
| Particles | Aspect Ratio | 15 | 15 | — |
| | Amount of Acid Adsorption A (μmol/m²) | 2.5 | 4 | — |
| | Amount of Base Adsorption B (μmol/m²) | 2.3 | 1.5 | — |
| | Adsorption Amount Ratio (A/B) | 1.1 | 2.7 | — |
| Plating | Filler Adhesion | A | B | — |
| Film | Scratches | A | A | B |

1. A composite hard chrome plating film comprising tabular alumina, wherein
the chromium source of the composite hard chrome plating film is trivalent chromium, and
the ratio A/B of the amount of acid adsorption A per surface area (μmol/m²) to the amount of base adsorption B per surface area (μmol/m²) of the tabular alumina is 0.5 or more and 1.5 or less.

2. The composite hard chrome plating film according to claim 1, wherein the amount of acid adsorption A of the tabular alumina is 0.5 μmol/m² or more and 3.5 μmol/m² or less.

3. The composite hard chrome plating film according to claim 1, wherein the tabular alumina has an average particle size of 1 μm or more and 20 μm or less and an aspect ratio of 5 or more and 100 or less.

4. The composite hard chrome plating film according to claim 1, wherein the tabular alumina further contains an atom or compound derived from a shape control agent.

5. The composite hard chrome plating film according to claim 4, wherein the shape control agent is a compound containing at least one member selected from the group consisting of silicon, germanium, sodium, and potassium.

6. The composite hard chrome plating film according to claim 1, wherein the tabular alumina further contains a molybdenum atom.

7. A sliding member coated with the composite hard chrome plating film according to claim 1.
